(19) United States
(12) Patent Application Publication
(10) Pub. No.: US 2009/0068332 A1
(43) Pub. Date: Mar. 12, 2009

(54) Appliance for shucking seed coverings from their kernals

(76) Inventor: Olajire Idowu, Lodi, CA (US)

Correspondence Address: Robert Charles Hill, 235 Montgomery Street #821, San Francisco, CA, 94104, US

(21) Appl. No.: 11/899,449

(22) Filed: Sep. 6, 2007

(51) Int. Cl. A23N 5/08; B02B 3/00

(52) U.S. Cl. 426/483; 99/521; 99/602

(57) ABSTRACT

A seed shucking appliance for separating seed coverings from their kernels comprises a vertical cylinder within which is rotated an upward pointing and rotating cone. The top surfaces of the cone and the inside surfaces of the cylinder are roughened to catch and grate the skins or hulls off water-softened beans or grains poured in from above. The clearances and textures between the roughened cone and inside cylinder are such that most of the skins or shells stay above the cone after being knocked loose, and the bared seed kernels drop down through without necessarily being ground up or smashed. What drops through is sent to a water bath where any remaining skins or shells are floated away. The bared seed kernels are drained and ready to be used as whole seed kernels in various kinds of foods.

### BACKGROUND OF THE INVENTION

1. Field of the Invention

The present invention relates to methods and apparatus for shucking the skins or hulls from seeds, including those of legumes, grains, drupes, silques, and achenes. In particular, the present invention relates to a rotating cone and cylinder with opposing rough lower edges to knock the softened skins or shells loose, and water floatation to carry the shucks away.

2. Description of Related Art

According to the Congo Cookbook, Moyin-Moyin (also called Moin-Moin, Moi-Moi, Moimoi), prepared from black-eyed peas or other beans, is a unique and delicious savory bean pudding. (See, www.congocookbook.com/snack_recipes/moyin_moyin.html) The traditional way to cook Moyin-Moyin is to make a paste ground from the shucked seeds. The paste is wrapped in banana leaves, and then steamed until cooked. In modern Africa, Moyin-Moyin is cooked in tin cans, or muffin pans or tins.

To start, the whole black-eyed peas have to be soaked or boiled in water until the skins are soft enough to be shucked by pinching or rubbing them off. The traditional way has been for each cook to manually rub the softened beans together to remove the skins. A rinse is used to wash away the skins and any other debris. The remaining bare seeds are drained in a colander and ground into a paste for the pudding.

Removing the skins, or shucks, from whole black-eyed peas this way is very tedious, labor intensive, and time consuming. Many different food uses of legumes, grains, drupes, silques, achenes, and other seeds call for removing the skins or hulls. The prior art has developed a wide variety of separation and grating methods, only a few of which are affordable and practical for home use.

Many prior art food graters grind the food into shavings without removing any peel, as in cheese graters. Others grind off peels that cannot be removed as skins, as in raw potato peelings. The foods of interest here are, e.g., seeds, peas, or beans where the skins can be removed whole, even if soaking or boiling is needed to soften the skins or seed coverings for complete removal and separation.

### SUMMARY OF THE INVENTION

Briefly, a seed shucking embodiment of the present invention for separating seed coverings from their kernels comprises a vertical cylinder within which is rotated an upward pointing and rotating cone. The top surfaces of the cone and the inside surfaces of the cylinder are roughened to catch and grate the skins or hulls off water-softened beans or grains poured in from above. The clearances and textures between the roughened cone and inside cylinder are such that most of the skins or shells stay above the cone after being knocked loose, and the bared seed kernels drop down through without necessarily being ground up or smashed. What drops through is sent to a water bath where any remaining skins or shells are floated away. The bared seed kernels are drained and ready to be used as whole seed kernels in various kinds of foods.

An advantage of the present invention is that a device is provided that quickly and easily removes the skins or shells from water-softened beans or grains.

Another advantage of the present invention is that a method is provided for preparing specialized foods at home.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a perspective diagram of a seed-shucking appliance embodiment of the present invention for separating seed coverings from their kernels; and

FIG. 2 is a perspective diagram of a floatation separation and rinsing device embodiment of the present invention useful in combination with the appliance of FIG. 1.

### DETAILED DESCRIPTION OF THE INVENTION

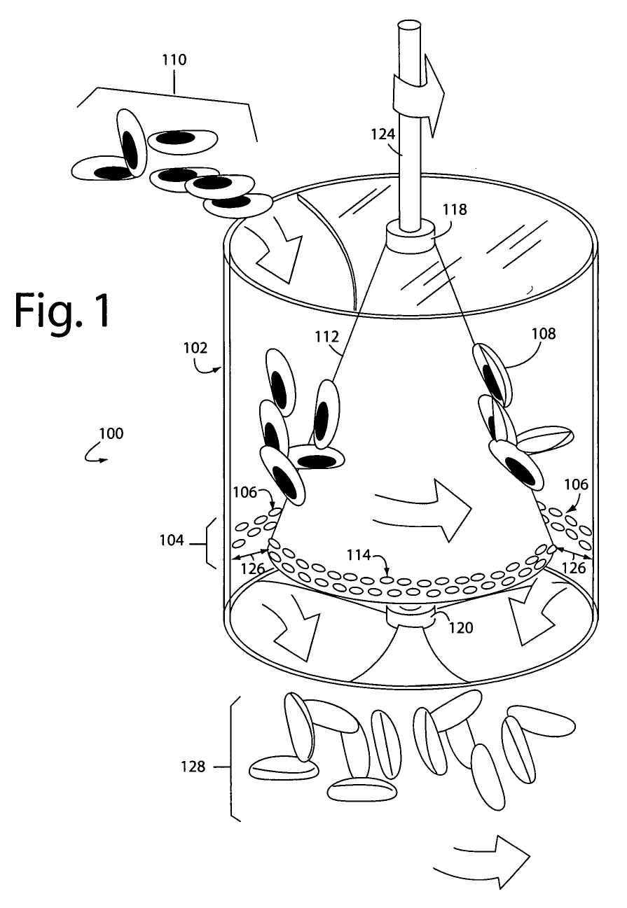

FIG. 1 represents a seed-shucking appliance embodiment of the present invention for separating seed coverings from their kernels, and is referred to herein by the general reference numeral 100. Appliance 100 includes a cylinder 102 with at least an inside wall section 104 provided with a roughened surface 106 able to snag seed coverings 108 from whole seeds 110. A cone 112 coaxially rotates inside the cylinder and is also provided with a roughened surface 114 at its outer circular perimeter 116 for catching the seed coverings 108 in opposition to the adjacent surfaces inside the cylinder. A set of bearings 118 and 120 are attached to the cylinder and cone to maintain a particular separation distance 122 between the roughened surfaces 106 and 114. The arrangement is suitable for shucking the skins off particular whole seed foods. A crankshaft 124 is used for turning the cone inside the cylinder on the bearings, and can be hand turned, or motor turned during use.

Particular kinds and sizes of whole seed foods are dropped in one top end of the cylinder 102 and pass down to where the cone 112 is nearest to the inside walls of the cylinder. The operation of the crankshaft 124 and roughened surfaces 106 and 114 causes the seed kernels to be stripped bare of their skins and to drop through the gap 126. Such gap 126 is not so narrow as to grind or reduce the bare seed kernels themselves. A mix 128 of bared seed kernels and some debris is sent on for floatation separation and rinsing.

In one embodiment suitable for home use, appliance 100 had a cylinder 102 about 8.5″ long and seven inches in diameter. Handles were fitted to the sides, and a hand crank allowed the user to manually turn crankshaft 124. A snap-on plastic cover was fitted to the bottom of cylinder 102 to allow the mix 128 of bared seed kernels and debris to be collected for the next step in the food preparation.

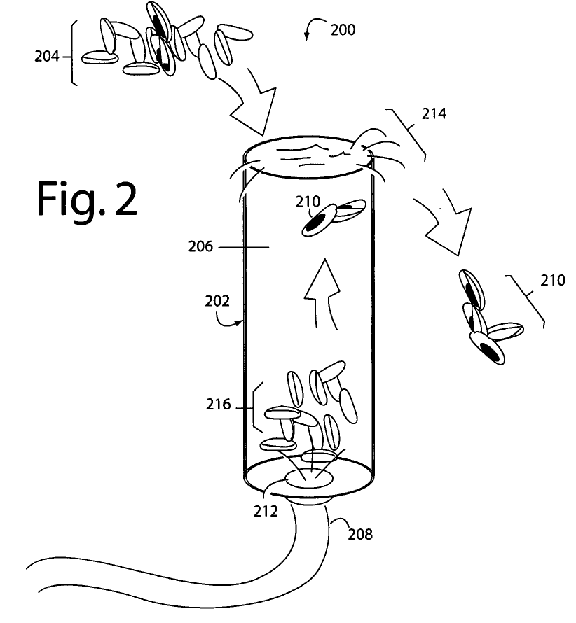

FIG. 2 represents a floatation separation and rinsing device embodiment of the present invention, and is referred to herein by the general reference numeral 200. Device 200 includes a cylinder bath 202 into which bared seed kernels and shucks 204 are introduced. It is filled with water 206 from a hose 208 at the bottom such that any remaining shucks 210 are floated off. Hose 208 can be attached to a kitchen sink faucet for home use. A water port 212 is fitted to the bottom of the bath 202 for both filling it enough to float off remaining shucks 210 in a spill water 214 and to jet-agitate any material 216 settling near the bottom. The force of water flow is kept low enough so only the bare seed kernels will stay. Once only the seed kernels remain, they can be drained and used in the food recipe.

In alternative embodiments, a colander can be placed to catch spill water 214 and shucks 210. Appliance 100 and device 200 can be combined to form a kitchen utensil set. Such aids will be particularly useful in situations where a medium to large dinner is being prepared and there simply is no staff or time available to engage in the traditional seed-by-seed skin peeling.

Although particular embodiments of the present invention have been described and illustrated, such was not intended to limit the invention. Modifications and changes will no doubt become apparent to those skilled in the art, and it was intended that the invention only be limited by the scope of the appended claims.

The invention is claimed, as follows:

1. A seed-shucking appliance for separating seed coverings from their kernels, comprising:
a cylinder with at least an inside wall section provided with a roughened surface able to snag seed coverings;
a cone for coaxial rotation inside the cylinder and also provided with a roughened surface at its outer circular perimeter for catching said seed coverings in opposition to similar surfaces inside the cylinder;
a set of bearings attached to the cylinder and cone to maintain a particular separation distance between said roughened surfaces suitable for shucking the skins off particular whole seed foods; and
a crank for turning the cone inside the cylinder on the bearings;
wherein, said particular whole seed foods are dropped in one top end of the cylinder and pass down to where the cone is nearest to the inside walls of the cylinder, and the operation of the crank and roughened surfaces causes bared seed kernels to drop through.

2. The appliance of claim 1, further comprising
a bath into which said bared seed kernels are introduced, and in which any remaining shucks are floated off.

3. The appliance of claim 2, further comprising
a water port fitted to the bottom of the bath for filling it enough to float off any remaining shucks and to agitate any material settling near the bottom.

4. The appliance of claim 2, further comprising
a drain for removing a bath water from said bared seed kernels after said remaining shucks have been floated off.

5. A method for separating seed coverings from their kernels after softening the skins, comprising:
rubbing whole seeds between a roughened cylinder wall and roughened upward pointing cone by rotating the cone fully within the cylinder;
fixing a gap between the inside of the cylinder and outside perimeter of the cone to allow whole seed kernels to drop through and yet for most of the removed seed coverings to remain above;
separating any seed coverings that do fall through from said whole seed kernels by floatation; and
wherein, said whole seed kernels are useful in a food recipe.

6. The method of claim 5, further comprising in the step of separating:
using a water port fitted to the bottom of a bath to filling it enough to float off any remaining shucks and to agitate any material settling near the bottom.

7. The method of claim 5, further comprising after the step of separating:
removing a bath water from said bared seed kernels after said remaining shucks have been floated off.
